(19) United States
(12) Patent Application Publication
(10) Pub. No.: US 2024/0198378 A1
(43) Pub. Date: Jun. 20, 2024

(54) WET COLLECTION OF COATING EXHAUST FROM FOOD-PRODUCT COATING APPARATUS

(71) Applicant: Ryan D. Nothum, Springfield, MO (US)

(72) Inventor: Ryan D. Nothum, Springfield, MO (US)

(21) Appl. No.: 18/522,862

(22) Filed: Nov. 29, 2023

Related U.S. Application Data
(60) Provisional application No. 63/385,284, filed on Nov. 29, 2022.

(51) Int. Cl. B05C 11/10; A23P 20/12

(52) U.S. Cl. CPC B05C 11/1039; A23P 20/12

(57) ABSTRACT

A wet collection apparatus is provided for collecting dry coating material exhaust from food-product coating apparatus for dusting or coating food product pieces (eg., chicken tenders) in automatic and/or mechanized food-process lines. There is a water vessel with a bottom wall, surrounding sidewalls, an open top, a removable closure for the open top, an exhaust blower mounted on or pneumatically-coupled to the vessel or closure, and a vacuum line extending between and pneumatically-coupled to both the food-product coating apparatus and one of the vessel or closure. The water vessel being characterized by a generally hollow interior defining a process chamber. Then there are a plurality of channel-dividing partitions mounted in the hollow interior of the water vessel forcing the flow of exhaust air through the process chamber to submerge and re-emerge into and out of the pool of water in a chutes and ladder fashion.

### CROSS-REFERENCE TO PROVISIONAL APPLICATION(S)

This application claims the benefit of U.S. Provisional Application No. 63/385,284, filed Nov. 29, 2022. The foregoing patent disclosure is incorporated herein by this reference thereto.

### BACKGROUND AND SUMMARY OF THE INVENTION

The invention generally relates to automatic and/or mechanized food-process line equipment and, more particularly, to wet collection of coating exhaust from food-product coating apparatus. Generally, the coating material is going to be dry particulate (eg., flour and spices) rather than wet coating material (eg., batter).

A number of additional features and objects will be apparent in connection with the following discussion of the preferred embodiments and examples with reference to the drawings.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a perspective view of portions of an automatic and/or mechanized food-process line comprising a line of food processing equipment including, in which in focus in the center is a food-product coating apparatus for dusting or coating food product pieces (such as and without limitation chicken tenders):—
in the foreground, it is attended to by a hopper for replenishing the dry particulate coating material as the exiting food product pieces on the discharge conveyors continually carry away and deplete/drain it of its original charge of coating material, and
in the background, it is attended by a wet collection apparatus in accordance with the invention for collecting coating material exhaust from said food-product coating apparatus;

FIG. 2 is an enlarged-scale perspective view of the wet collection apparatus in isolation;

FIG. 3 is cross-sectional view taken along line 3-3 in FIG. 2 showing an enclosed steel-plate cabinet defining a process chamber in accordance with the invention sub-divided into a series of side-by-side generally vertical channels by means of a series of steel-plate channel-dividing partitions;

FIG. 4 is cross-sectional view taken along line 4-4 in FIG. 3;

FIG. 5 is an enlarged-scale sectional view comparable to FIG. 3 except showing the process chamber containing a shallow pool of water at rest before switching the electric-motor driven high-powered exhaust blower (suction fan or vacuum pump) to ON, wherein the arrows show the course of the exhaust flow through the process chamber and as winding around channel-dividing partitions in a chutes and ladder fashion;

FIG. 6 is a sectional view comparable to FIG. 5 except showing the process chamber moments after switching the exhaust blower to ON;

FIG. 7 is a sectional view comparable to FIG. 6 except showing the process chamber in an exemplary state of full churn after the exhaust blower has been switched to ON for several minutes;

FIG. 8 is a sectional view comparable to FIG. 7 except showing the process chamber in an alternate exemplary state of full churn after the exhaust blower has been switched to ON for several minutes, wherein the states in the process chamber oscillate between one extreme (eg., FIG. 7) and another (eg., FIG. 8) wherein one of the nozzles is flooded with water until a back pressure of air builds up and burst through in a bubbly foggy jet of a mixture of air, silty water droplets and dust;

FIG. 9 is an enlarged-scale detail view of the lower third of FIG. 7;

FIG. 10 is an enlarged-scale perspective view of detail 10-10 in FIG. 8 that shows that, while some fraction of the particulate might sink in the pool to form a bottom layer of sediment, other fractions of the particulate form floating rafts in the first channel of the processor where the original inflow of exhaust air from the food-product coating apparatus is received, wherein the pool is relatively calmer here and less subject to the oscillations induced by the first nozzles; and

FIG. 11 is a generalized curve showing pressure (P) on the Y-axis representing pressure under the hood of the food-product coating apparatus, and flowrate (f) on the X-axis and representing exhaust blower flowrate/output to atmosphere.

### DETAILED DESCRIPTION OF THE PREFERRED EMBODIMENTS

FIG. 1 show portions of an automatic and/or mechanized food-process line comprising a line of food processing equipment including, in the center, a food-product coating apparatus for dusting or coating food product pieces such as and without limitation chicken tenders.

Examples of food-product coating apparatus might include for example and without limitation what is disclosed in U.S. Pat. No. 9,687,018—Nothum, Jr., et al., “Food process-line coating apparatus with exchangeable substitution or elimination of accessories of the tumbling and/or flipping nature.” Or, for another example and without limitation, what is disclosed in U.S. Pat. No. 8,096,259—Nothum, Jr., et al., “Gutters and plows for coating-material recirculation in food-coating apparatus.”

Food product pieces (eg., chicken nuggets) are typically serially conveyed on endless wire-mesh conveyor belts through a series of food-product line processing equipment where at least on food process line operation is performed, such as dry coat, wet coat, dry coat again, par-fry and so on to packaging and freezing.

The food-product coating apparatus is flanked between the discharge conveyor of an immediately upline machine and an immediately downline transfer conveyor. The food-product coating apparatus has a steel-plate cabinet covered by a hood. The food-product coating apparatus is attended to in part by a hopper for replenishing the food-product coating apparatus with dry particulate coating material as the exiting food product pieces on the discharge conveyors continually carry away and drain/deplete said food-product coating apparatus of its original charge of coating material.

The food-product coating apparatus is attended to in other part by a wet collection apparatus in accordance with the invention for collecting coating material exhaust from food-product coating apparatus. Generally, the coating material is going to be dry particulate (eg., flour and spices) rather than wet coating material (eg., batter).

Food-product coating apparatus in automatic and/or mechanized food-process lines typically receive a constant inflow of food product pieces (eg., chicken nuggets) and coat them by various processes with a dust or powdery coating (eg., flour and spices and so on). Such coating apparatus must also receive a periodic replenishment of the coating material (eg., fresh flour, with or without an admixture of spices or other additions).

Some of these ‘various processes’ for coating the food product pieces include without limitation drum tumbling in a horizontal drum. Inside the drum, the food product pieces and coating material are being tumbled such that the atmosphere inside the drum is cloudy with a wafting, swirling fraction of the coating material. In other words, there is a dust storm churning inside the drum. The designed-for outflow from the drum is coated food-product pieces. The unwanted outflow might also be escaped atmosphere from inside the drum, including the suspended fraction of coating material.

It is possible to contain the escape of suspended coating material if the inflow and outflow apertures for the intake and discharge of food product pieces are low-height slits just tall enough for passage of the conveyor belts and food product pieces, and then also if in combination, a negative pressure is maintained inside the drum. That way, the inflow and outflow channels are always inhaling external air (which is presumably free of or at least relatively free of suspensions).

To do so requires a vacuum line that draws a cloudy exhaust mixture from the drum. The vacuum line runs from a connection in the hood of the food-product coating apparatus to a connection with the wet collection apparatus in accordance with the invention.

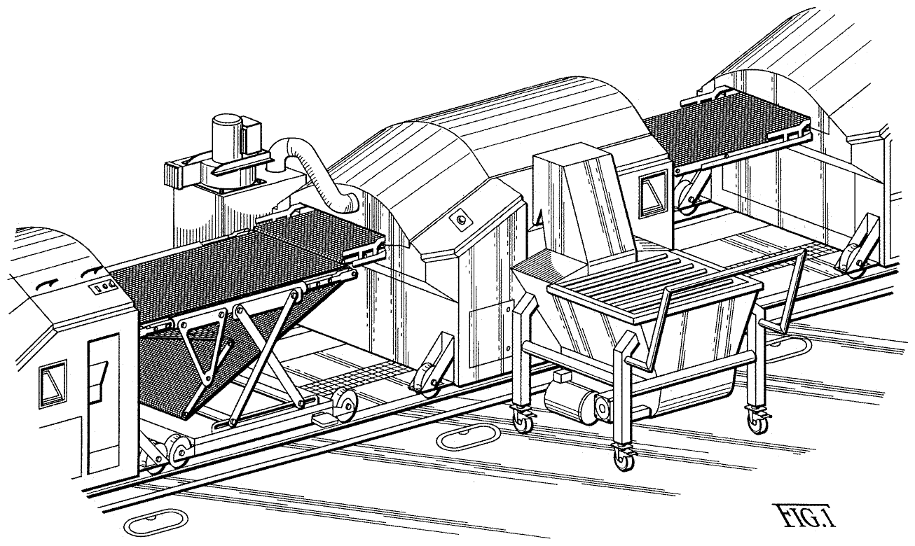

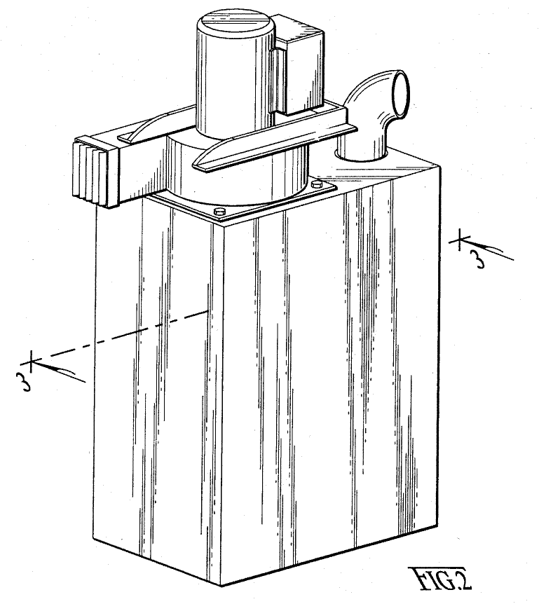

FIG. 2 shows the wet collection apparatus in isolation. The wet collection apparatus comprises a water-tight stainless-steel plate cabinet (vessel) with a rectangular bottom wall, four rectangular sidewalls and an open top covered by a removable lid or closure. The cabinet has a generally hollow interior with a bottom wall (floor plan) that is about four feet by three feet rectangular, and sidewalls that are about four feet high. The cabinet is essentially a water vessel for the shallow pool of water. However, it is alternately preferred to have an outer cabinet that is not required to be watertight housing a water vessel and closure which are cooperatively watertight, except for the pneumatic connections.

The lid or closure is provided with a termination end-point connection for the vacuum line from the hood of the food-process coating apparatus, as shown on the upper right side of the lid or closure. The rest of the real estate on top of the lid or closure is taken up by a combination set of a powerful electric drive motor and a driven exhaust blower fan. The blower suctions (or draws) exhaust air (eg., a coating material-laden mixture) from inside the cabinet of the food-product coating apparatus. Again, this exhaust flow is a mixed flow of air and suspended coating material from out of the food-product coating apparatus.

At best, the exhaust blower induces a ‘rough’ vacuum inside the food-product coating apparatus (not even a half atmosphere). But at least the exhaust blower draws a sufficient negative pressure such that the food-product coating apparatus ‘inhales’ fresh air through the narrow slits at the inlet for the infeed conveyor and outlet for the discharge conveyor. That way, the dust storm inside the food-product coating apparatus is fairly contained within its cabinet and hood.

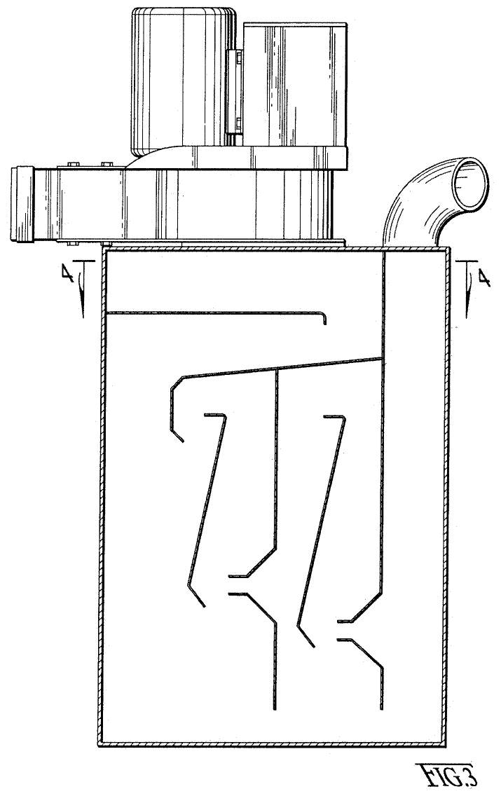

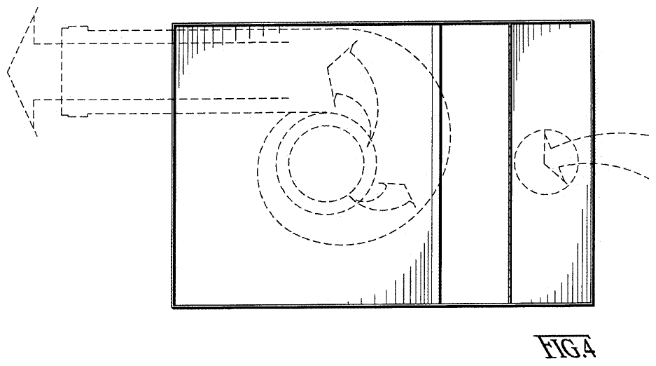

FIGS. 3 through 8 are similar cross-sectional views taken along line 3-3 in FIG. 2 and showing the inside of the cabinet, which comprises a process chamber. FIG. 4 is a top plan view of the lid or closure, and showing the relative inflow of exhaust gas from the food-product coating apparatus as drawn into the wet collection apparatus through the terminal-fitting connection for the vacuum line. FIG. 4 also shows the ultimate discharge of the relatively filtered or ‘scrubbed’ exhaust air into the local atmosphere by the powerful exhaust blower, also mounted on top of the lid or closure.

FIG. 3 shows the interior of the process chamber is divided up into a series of flow channels or cells by means of a series of steel-plate channel-dividing partitions. The terms channels is intended to describe regions bounded by not only the channel-dividing partitions:—but also by the sidewalls, bottom wall and closure as well.

The term cell is intended to describe certain flow phenomena:—in particular, induced swirls that rotate in place like a spinning log chucked in a lathe.

FIG. 3 shows that the cabinet has an inflow-side sidewall and a spaced away discharge-side sidewall cooperatively flanking:
a bottom wall, and
two endwalls (only one in view in FIG. 3, but see FIG. 4).

The channel-dividing partitions extend into and out of the view of FIG. 3 from one endwall to the opposite spaced away endwall, and are welded or otherwise fixed in place. Again, the channel-dividing partitions run the whole length between endwall to endwall, and again see FIG. 4.

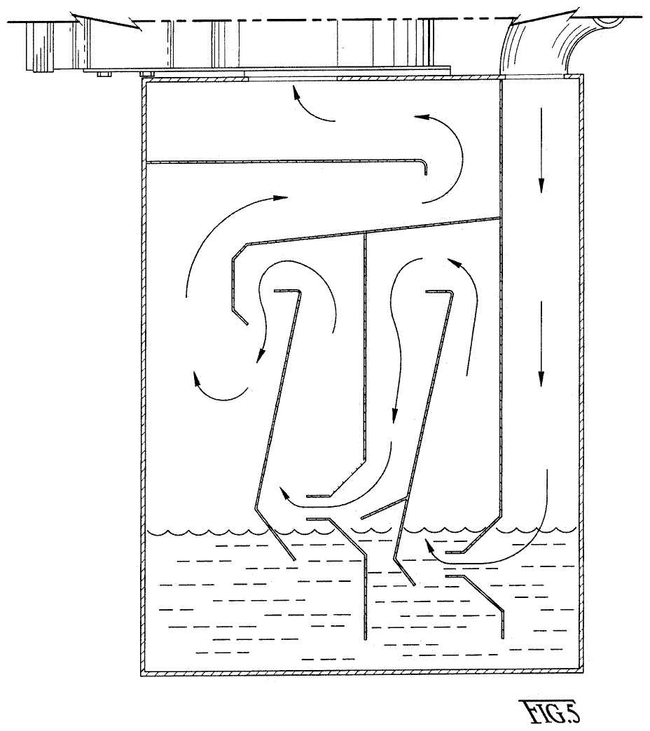

To stay in FIG. 3, the flow-bounding structures which characterize the process chamber include, starting at the far right and proceeding clockwise:—
the inflow-side sidewall,
the bottom wall,
a first nozzle-formed partition,
a first Z-formed backstop partition,
a second nozzle-formed partition,
a second Z-formed backstop partition,
a roof enclosing the head space above the first Z-formed backstop partition between the first nozzle-formed partition and the top edge of the second nozzle-formed partition,
an eave continuation of the roof projecting over the second Z-formed backstop partition,
the discharge-side sidewall,
a horizontal shelf projecting inwards from the discharge-side sidewall and spaced over the roof and its eave continuation as well as space below the closure, and
the closure.
   The first and second nozzle-formed partitions are ‘daylighted’ at their bottoms in that they have bottom edges that are spaced by a common-height gap from the bottom wall. To look at FIG. 5 (among others), the water of the pool of water is free to migrate underneath these bottom edges however it wants to.

The first nozzle-formed partition has a top edge common with the elevation of the closure. The second nozzle-formed partition has a top edge which, as mentioned above, is joined to the partition that forms the roof and eave at where such partition transitions from roof to eave. The eave does not reach the discharge-side sidewall but instead leaves a flow channel therebetween.

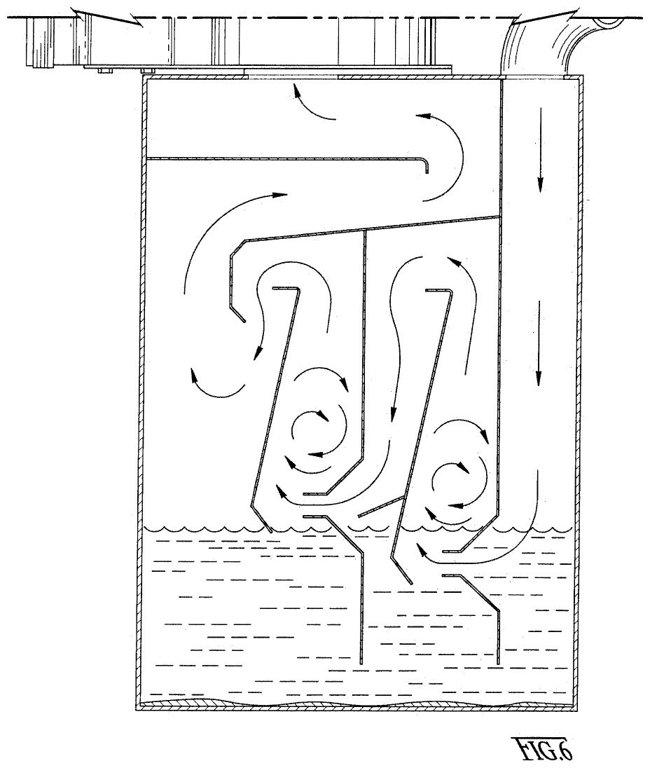

The first and second nozzle-formed partitions are actually defined by upper and lower spaced panels respectively. The upper and lower panels at where they are spaced apart and bent (creased) to form a funnel-shaped nozzle respectively. FIGS. 5 and 6 show the preferred fill line for the water pool at rest. The first nozzle-formed partition forms its respective nozzle at an elevation that is submerged below the static pool fill line. The second nozzle-formed partition forms it respective nozzle at an elevation that is emergent and dry over the static pool fill line.

The first and second Z-formed backstop partitions have respective upper ledges that are disposed at about a common elevation with each other.

However, the first Z-formed backstop partition has a central diagonal panel declining at an outward angle (eg., 7 o'clock on an imaginary clock dial in FIG. 3) and transitioning at a crease into a lower diagonal panel declining at an inward angle (eg., 5 o'clock on an imaginary clock dial in FIG. 3):—wherein the elevation of this first crease is centered on a horizontal plane of symmetry with the first funnel-shaped nozzle.

Correspondingly, the second Z-formed backstop partition has a central diagonal panel declining at an outward angle (eg., 7 o'clock on an imaginary clock dial in FIG. 3) and transitioning at a crease into a lower diagonal panel declining at an inward angle (eg., 5 o'clock on an imaginary clock dial in FIG. 3):—wherein the elevation of this second crease is centered on a horizontal plane of symmetry with the first funnel-shaped nozzle.

In other words, the first and second creases are at different elevations with respect to each other but are aligned at elevations in like proportions with respect to their respective first and second nozzles.

The creases thus formed sideways-V shaped ‘backstop partitions’ (eg., as shown in FIG. 3, “less than” sign shaped, or “<”). To turn to FIG. 6, these backstop partitions induce flow phenomena cells that, as previously characterized, form swirling storms that rotate in place on a horizontal axis like a spinning log chucked in a lathe. These swirling storms are referred to by applicant by their main contribution:—applicant refers to them as “water/dust mixing cells.”

FIGS. 5-10 show that the backside of the first Z-formed backstop partition has attached to it a declining vane aimed for deflecting flow into the second nozzle. That is, flow enters the first nozzle as in the manner of a side outlet in a T-shaped pipe fitting.

However, flow enters the second nozzle with the aid of being deflected therein by the well-aimed vane. FIG. 5 shows better that the flow pattern undertakes a serpentine path in the process chamber in accordance with the boundaries set by:—
the inflow-side sidewall,
the bottom wall,
the first nozzle-formed partition and its nozzle,
the first Z-formed backstop partition,
the second nozzle-formed partition and its nozzle,
the second Z-formed backstop partition,
the roof enclosing the head space above the first Z-formed backstop partition,
its eave continuation projecting over the second Z-formed backstop partition,
the discharge-side sidewall,
the shelf above the roof and its eave continuation but below the closure, and
the closure.
   The flow direction boundaries direct the flow in this sequence:—
a pair of down arrows indicate a downflow of exhaust air drawn in from the food-product coating apparatus heading down along the front side of the first nozzle-formed partition,
although indicated as the path being blocked by the water surface of the fill level of the static water pool, U-shaped arrow indicates flow through the first nozzle and up the front side of the first Z-formed backstop partition,
from this stage on the flow can be (sediment laden) water, (dust laden) air, or two phase admixtures thereof, and some flow might transit beneath either of the first or second nozzle-formed partitions (although not shown),
a pair of arrows cooperatively indicate an inverted U-turn over the top ledge of the first Z-formed backstop partition,
another U-shaped arrow indicates flow through the second nozzle and up the front side of the second Z-formed backstop partition,
a single inverted-U shaped arrow indicates an inverted U-turn over the top ledge of the second Z-formed backstop partition
a pair of arrows cooperatively indicate an recurve upward back turn around and over the eave,
another pair of arrows cooperatively indicate an recurve upward front turn around and over the shelf and out through the exhaust blower.
   FIG. 6 shows better where the first and second “water/dust mixing cells” develop with respect to the first and second nozzles and the respective first and second backstop partition therefor (and their respective crease portions).

Experience shows that the vast majority of the suspended fraction of coating material is caught/collected in the water as sediment. The outlet from the exhaust blower is more or less fresh air.

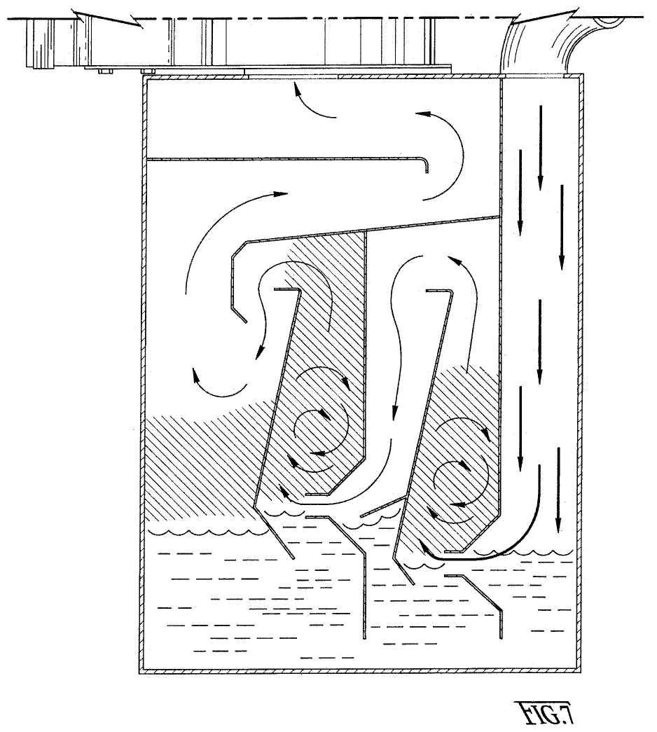

To turn to FIGS. 7-10, these are black line renditions of actual screen grabs from video taken of an actual proof-of-concept demonstration machine that had been provided with a transparent sidewall to show the air-water-dust flow patterns in operation.

Unlike what is shown in FIGS. 5 and 6, there is no ‘level’ water level as for a static water pool.

Without describing FIGS. 7 through 9 in detail, visual observations record that an oscillatory pattern sets up, between on sloshed state and another sloshed state:—and back and forth and so on setting a riotous amount of turbulence. Which is believed to be a beneficial outcome as just promoting more mixing more vigorously.

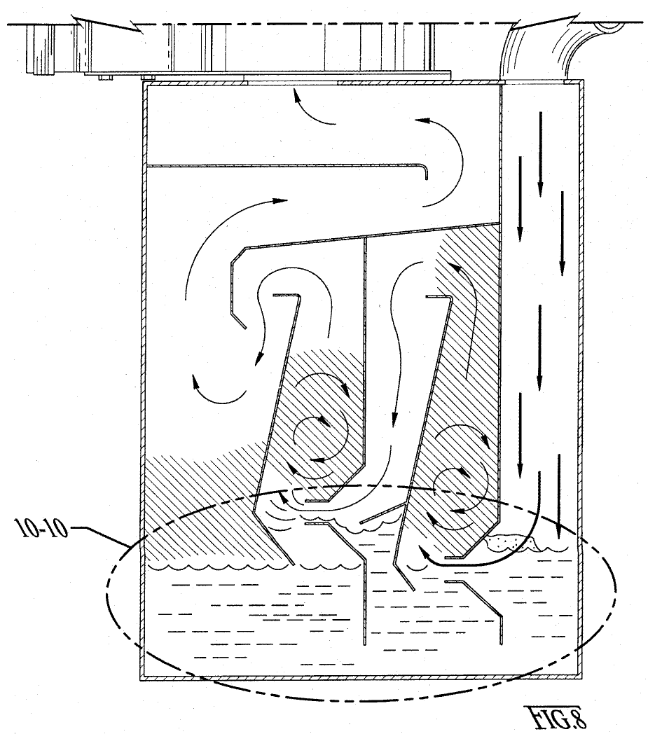

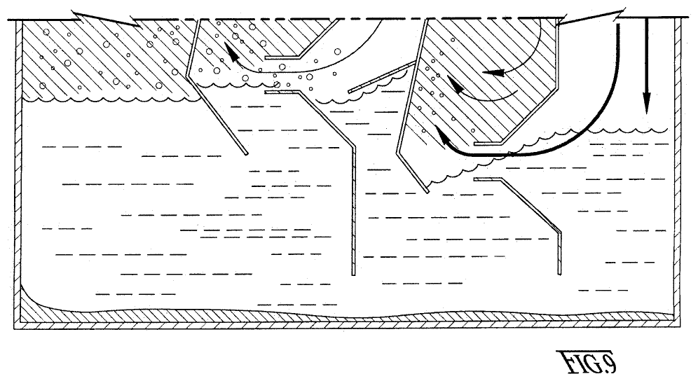

So FIG. 7 is a general representation of one sloshed state, FIG. 8 the other, and FIG. 9 is an enlarged scale detail view of the lower third or so of FIG. 7.

It is believed the mechanism which is by and large responsible for triggering this oscillation pattern occurs in the first nozzle. To recall basic physics, air is compressible, water is incompressible. And it is the compressibility of air which is believed to set up this mechanical-spring like oscillation.

That is, the one state (FIG. 7 or 9) has an air jet blasting through the first nozzle. The air expands past the nozzle, and not only expands upwardly, but downwardly too pushing the water level between the first nozzle-formed partition and first backstop partition to depress (drop). This causes water levels elsewhere in the process chamber to rise:—notably, along the discharge-side sidewall and under the second nozzle.

Then, the weight of the rising water levels starts to slosh the water level in front of the first nozzle to rise until the first nozzle is flooded (eg., FIG. 8). The air jet from the second nozzle is now expanding, and just like the first nozzle in FIG. 7, the jet through the second nozzle not only expands upwardly, but downwardly too pushing the water level between the second nozzle-formed partition and second backstop partition to depress (drop). This causes water levels elsewhere in the process chamber to rise, ie., and thereby returning to the state of FIG. 7.

The oscillations are not only visually evident but they also have a fairly steady periodicity.

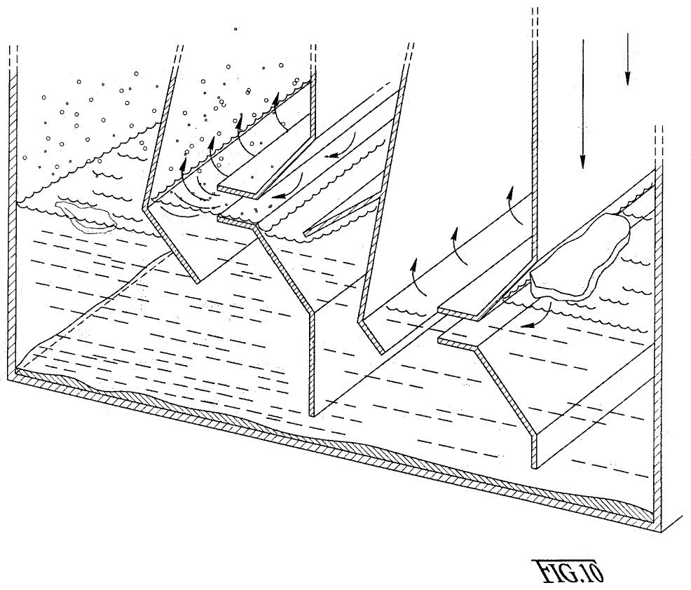

FIG. 10 shows that some of the dust originally forms floating rafts until those can be broken up an entrained as sediment in the water pool.

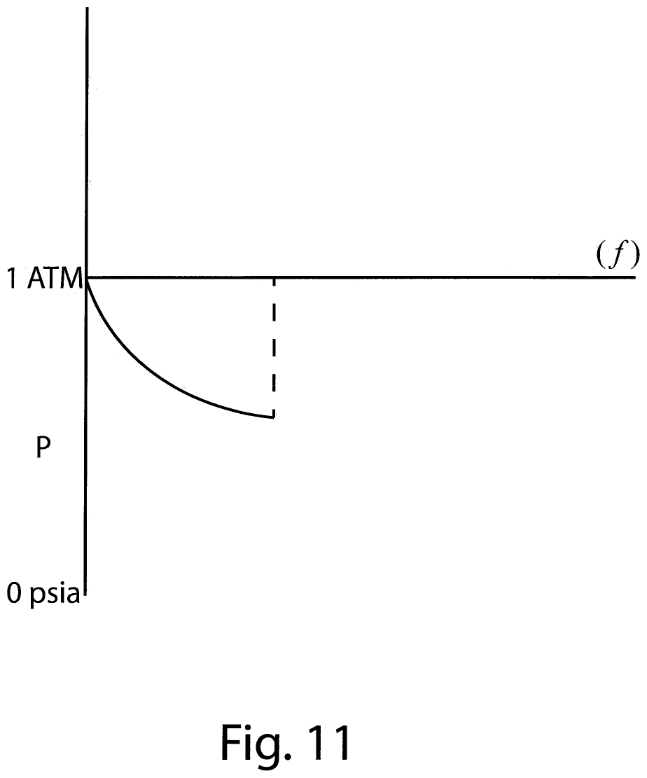

FIG. 11 is power curve showing the relation of increase in power to increase in vacuum (drop in pressure to absolute zero pressure). The vacuum levels here aren't very high, and in industry these levels of vacuum are referred to as “rough” vacuum.

More particularly, FIG. 11 shows pressure (P) on the Y-axis as representing pressure under the hood of the food-product coating apparatus, and flowrate (f) on the X-axis as representing exhaust blower flowrate/output to atmosphere. The power it takes to increase flowrate (f) is probably exponential to some degree.

What FIG. 11 shows is that, there are diminishing returns for increasing power and increasing flowrate to draw a deeper vacuum. The suction pressure of the exhaust blower will eventually become so great as to suction in pool water, which is a shutdown condition indicated by the broken line.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

What is claimed is:

1. A wet collection apparatus for collecting dry coating material exhaust from food-product coating apparatus for dusting or coating food product pieces (eg., chicken tenders) in automatic and/or mechanized food-process lines; comprising:
a water vessel with a bottom wall, a surrounding sidewall or sidewalls, and an open top;
a removable closure for the open top;
an exhaust blower mounted on or pneumatically-coupled to the vessel or closure;
a vacuum line extending between and pneumatically-coupled to both the food-product coating apparatus and one of the vessel or closure;
the water vessel being characterized by a generally hollow interior defining a process chamber; and
a plurality of channel-dividing partitions mounted in the hollow interior of the water vessel forcing the flow of exhaust air through the process chamber to submerge and re-emerge into and out of the pool of water in a chutes and ladder fashion.
